(19) United States
(12) Patent Application Publication
(10) Pub. No.: US 2026/0058716 A1
(43) Pub. Date: Feb. 26, 2026

(54) ADAPTIVE BEAM MANAGEMENT FOR MILLIMETER WAVE WIRELESS COMMUNICATION

(71) Applicant: QUALCOMM Incorporated, San Diego, CA (US)

(72) Inventors: Raj Kumar Krishna Kumar, Bangalore (IN); Tanumay Datta, Bangalore (IN); Subramanian Anantharaman, Bangalore (IN)

(21) Appl. No.: 18/811,500

(22) Filed: Aug. 21, 2024

(51) Int. Cl. H04B 7/06

(52) U.S. Cl. CPC H04B 7/06958

(57) ABSTRACT

Adaptive beam management techniques for millimeter wave wireless communication are disclosed. A wireless device performs a sector level sweep (SLS) to identify multiple transmit beams. The device obtains an indication of N best transmit beams and performs a beam refinement phase (BRP) for each, establishing a list of transmit-receive beam pairs. During operation, if a primary beam is blocked, the device can switch to an alternative beam from the list, indicating the change in request-to-send (RTS) frames. The system supports intelligent beam switching based on signal quality data, device location, quality of service requirements, and historical information. These techniques enable rapid adaptation to changing channel conditions, reducing link outages and improving overall system performance in dynamic environments.

### TECHNICAL FIELD

This disclosure relates generally to wireless communication, and more specifically, to adaptive beam management techniques for millimeter wave systems utilizing multiple beam feedback and dynamic beam selection.

### INTRODUCTION

Millimeter wave (mmWave) communication systems offer the potential for high-throughput and low-latency wireless connectivity, which is important for emerging applications such as extended reality (XR), gaming, and wireless display. However, mmWave systems face challenges related to beam management in dynamic environments where line-of-sight (LoS) paths can be frequently blocked.

Conventional mmWave systems generally identify and use only a single best beam for communication. When this beam becomes blocked, the system must perform a time-consuming full beam sweep to find an alternative, leading to significant link outages and increased latency. It follows that current approaches to handling beam blockages typically rely on periodic beamforming or blind retries of the blocked beam. These methods can be inefficient, causing unnecessary outages or delays in restoring optimal communication paths. Additionally, existing systems may not effectively utilize information about multiple promising beam directions, limiting their ability to adapt quickly to changing channel conditions.

In view of the foregoing, there is a need for more robust and efficient beam management techniques that can maintain high performance in dynamic mmWave environments. This is particularly true for applications demanding consistent low-latency connectivity.

### SUMMARY

The systems, methods and devices of this disclosure each have several innovative aspects, no single one of which is solely responsible for the desirable attributes disclosed herein.

Based on the final version of claims 1-20, here's a revised summary of the invention:

One innovative aspect of the subject matter described in this disclosure can be implemented in an apparatus for wireless communication. The apparatus includes at least one memory comprising computer-executable instructions and a processing system that includes processor circuitry and memory circuitry that stores code. The processing system is configured to cause the apparatus to perform a sector level sweep (SLS), wherein the performance comprises sweeping through a plurality of transmit beams; obtain an indication of a set of N best transmit beams associated with the SLS, where N is an integer greater than one; and perform a beam refinement phase (BRP) associated with the indication for the N best transmit beams.

In some examples, the apparatus obtains an indication of a set of best transmit-receive beam pairs associated with at least one of the SLS, the BRP, or a neighbor-network report. In other examples, the apparatus obtains a signal quality indicator for each of the N best transmit beams or obtains a signal quality difference between two or more of the N best transmit beams. The apparatus may also obtain an indication of a blockage associated with a first transmit beam in the set of N best transmit beams and output, for transmission, a request-to-send (RTS) frame using a second transmit beam in the set of N best transmit beams, the RTS frame including an indication of the second transmit beam. The apparatus may further switch between transmit beams in the set of N best transmit beams based on signal quality data or a configured switch time, where the configured switch time may be associated with the location of the apparatus, a quality of service (QoS) requirement, or telemetry data.

Another innovative aspect of the subject matter described in this disclosure can be implemented in an apparatus for wireless communication. The apparatus includes at least one memory comprising computer-executable instructions and a processing system that includes processor circuitry and memory circuitry that stores code. The processing system is configured to cause the apparatus to operate in an omni receive mode during a sector level sweep (SLS), wherein the operation comprises sweeping through a plurality of transmit beams; identify, based on the operation, a set of N best transmit beams, where N is an integer greater than one; and output, for transmission, an indication of the set of N best transmit beams.

In some examples, the apparatus ranks a set of best transmit-receive beam pairs, where the rank is based on the SLS and BRP. The apparatus may also obtain a request-to-send (RTS) frame that includes an indication of a transmit beam and output, for transmission, a clear-to-send (CTS) frame using a receive beam corresponding to the transmit beam. Additionally, the apparatus may obtain an indication of a blockage of at least one of a first transmit beam and a second transmit beam in the set of N best transmit beams, and output, for transmission, a communication on a third best transmit beam from the set of N best transmit beams.

A further innovative aspect of the subject matter described in this disclosure can be implemented in another apparatus for wireless communication. This apparatus is configured to obtain, based on a sector level sweep (SLS) of a plurality of transmit beams, an indication of a set of N best transmit beams in the plurality of transmit beams, where N is an integer greater than one; perform a beam refinement phase (BRP) for each of the N best transmit beams; obtain an indication of a blockage associated with a first transmit beam in the set of N best transmit beams; and output, for transmission, a request-to-send (RTS) frame via a second transmit beam in the set of N best transmit beams, the RTS frame including an indication of the second transmit beam. In some examples, this apparatus is further configured to detect a removal of the blockage associated with the first transmit beam, output for transmission an RTS frame using the first transmit beam, and obtain a clear-to-send (CTS) frame after outputting the RTS frame.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a flowchart illustrating an example process performable by or at a wireless communication device acting as an initiator that supports adaptive beam management for millimeter wave wireless communication.

FIG. 3 shows a flowchart illustrating an example process performable by or at a wireless communication device acting as a responder that supports adaptive beam management for millimeter wave wireless communication.

FIG. 4 shows a flowchart illustrating an example process performable by or at a wireless communication device that supports adaptive beam management and blockage handling for millimeter wave wireless communication.

FIG. 5 shows a block diagram of an example wireless communication device that supports adaptive beam management for millimeter wave wireless communication.

FIG. 6 shows a signaling diagram illustrating an example process for adaptive beam management between an initiator device and a responder device in a millimeter wave wireless communication system.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3^{rd} Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication systems millimeter wave (mmWave) systems are integrated with sub-7 GHz Wi-Fi links to address demand for high-throughput and low-latency performance. These systems aim to support next-generation use cases such as extended reality (XR), gaming, wireless display, and device sharing/collaboration. However, mmWave communications face challenges related to range limitations, mobility issues, and link reliability in dynamic environments where line-of-sight paths can be frequently obstructed. Traditional beam management techniques in mmWave systems struggle to maintain robust connections in such scenarios, leading to increased latency and degraded user experience. The need for enhanced link robustness and consistent low-latency performance in these integrated mmWave systems presents a problem that suggests a need for new approaches to beam management.

Various aspects relate generally to wireless communication and more particularly to beam management techniques in millimeter wave (mmWave) systems. Some aspects more specifically relate to improved methods for sector level sweep (SLS) procedures, beam refinement phase (BRP) operations, and adaptive beam selection in the presence of blockages.

In some examples, a wireless communication device performs a sector level sweep (SLS) by sweeping through a plurality of transmit beams. The device then obtains an indication of a set of N best transmit beams, where N is an integer greater than one. This allows for the identification of multiple beam directions rather than only a single best beam. The device subsequently performs a beam refinement phase (BRP) for the N best transmit beams to identify a corresponding set of best receive beams. This two-stage process enables the device to narrow optimal transmit-receive beam pairs for communication.

The system also incorporates adaptive techniques to handle dynamic environments. For instance, if a blockage is detected for a primary beam, the device can switch to an alternative beam from the set of N best beams. The device may output a request-to-send (RTS) frame using this alternative beam, including an indication of the beam being used. This allows for adaptation to changing channel conditions without requiring a full re-sweep of all possible beams.

Further, the system supports intelligent beam switching based on various factors. The device may store data indicating signal quality of the set of N best transmit beams and switch between these beams based on this data or a configured switch time. The configured switch time can be adaptive and consider factors such as device location, quality of service (QoS) requirements, or historical telemetry data.

Particular aspects of the subject matter described in this disclosure can be implemented to realize one or more of the following potential advantages. By obtaining an indication of a set of N best transmit beams, some aspects provide increased resilience to beam blockages and channel fluctuations. This enables the system to maintain multiple viable communication paths, reducing the likelihood of link failure.

The performance of a beam refinement phase (BRP) for each of the N best transmit beams to identify a corresponding set of best receive beams allows for precise beam alignment. By refining multiple beam directions rather than just the single best beam, some aspects enable improved link reliability and higher data rates through the selection of matched transmit-receive beam pairs.

By implementing adaptive techniques to handle blockages, such as switching to an alternative beam from the set of N best beams when a primary beam is blocked, some aspects enable adaptation to changing channel conditions. This can reduce communication disruptions in dynamic environments and improve system responsiveness and user experience.

The inclusion of beam information in request-to-send (RTS) frames allows for coordination between devices. By indicating which beam is being used in the RTS frame, some aspects enable the receiving device to adjust its receive beam, thereby reducing the time required to establish or re-establish communication links.

The intelligent beam switching approach, which considers factors like signal quality data, device location, quality of service (QoS) requirements, and historical telemetry data, enables efficient use of network resources. By tailoring the beam selection and switching behavior to specific scenarios, some aspects allow for optimization of performance metrics such as throughput, energy efficiency, and overall network capacity.

Also, the two-stage process of sector level sweep (SLS) followed by beam refinement phase (BRP) strikes a balance between broad exploration and fine-tuning. This approach allows the system to narrow down transmit-receive beam pairs without exhaustively testing all possible combinations. This can reduce the time and energy required for beam management compared to more brute-force methods.

By maintaining and utilizing information on multiple promising beam directions, some aspects reduce the need for frequent full beam sweeps. This reduces overhead in beam management processes, thereby improving system scalability and allowing for support of a larger number of devices in dense deployment scenarios.

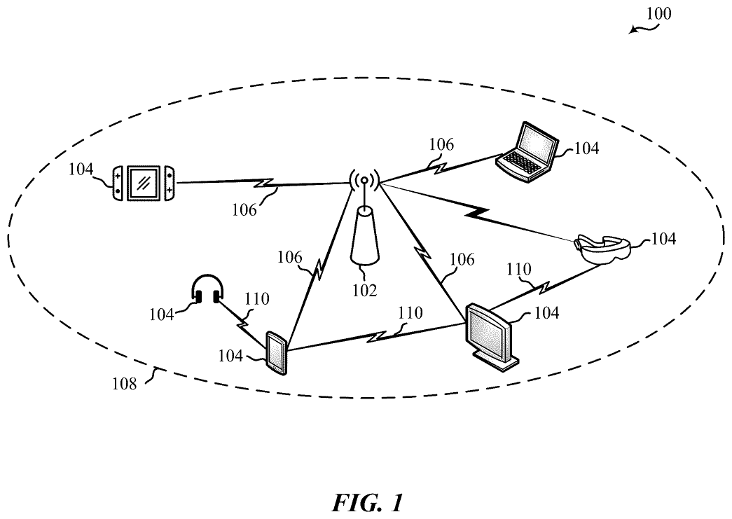

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices or wireless nodes including a wireless access point (AP) 102 and any number of wireless stations (STAs) 104. Either or both of AP 102 and STA can be considered a wireless node. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MH channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR-or IEEE 802.11bn-compatible) devices for opportunistic access to spectrum that may be otherwise under-utilized.

In some wireless communication systems, wireless communication devices (such as an AP 102 and STAs 104 described with reference to FIG. 1) may operate via one or more wireless communication links in a frequency band higher than a sub-7 GHz (sub7, such as a 2.4 GHz frequency band, a 5 GHz frequency band, or a 6 GHz frequency band) frequency band. In some such wireless communication systems, the AP 102 and STAs 104 may communicate on a wireless communication link in a millimeter wave (“mmWave” or “mmW”) band (for example, a frequency band between 30 GHz and 300 GHz, such as a 60 GHz frequency band). A wireless communication system supporting such mmWave communications (such as AP 102 and STAs 104 in wireless communications network 100) may use integrated mmWave (IMMW) techniques to support operations in these frequency bands. To manage the relatively high attenuation losses and other path losses associated with the mmWave band, the AP 102 and STAs 104 may transmit and receive directional communications via beamforming procedures. To select or otherwise generate directional beams in the mmWave band, a wireless communication device may perform beam sweeping, searching and training operations, which may involve various training and feedback reporting packet sequences. In some wireless communication systems, a mmWave link supports data communications while a sub7 link may be used for management and control information signaling to support the mmWave communications. For example, a STA 104 may first associate with an AP 102 to establish a sub7 link, and thereafter, perform beam searching and training in the mmWave band to establish a mmWave link for the communication of data. In such examples, the sub7 link may be referred to as an anchor link.

In addition to beam searching and training procedures, an AP 102 and a STA 104, after having selected a beam pair, may perform beam management and recovery procedures, including periodic beacon-based procedures and aperiodic STA-initiated fast link recovery procedures, which may involve the use of beam recovery sequences. The AP 102 and STAs 104 may use these beam management and recovery procedures for beam sync-up and identifying broken links. When communicating via a mmWave link, the AP 102 and STAs 104 may perform various channel access procedures including contention-based access procedures, target wake time (TWT)-based access procedures (including the use of dedicated and opportunistic service periods (SPs)), scheduled-mode access procedures, and triggered-mode access procedures. The APs 102 and STAs 104 operating in the mmWave band also may support various management frame optimizations and procedures including optimizations and procedures associated with discovery, scanning, association, roaming, link setup, updates and maintenance, and the initial and continuing configuration of BSS and link-specific parameters including channel selection and rate adaptation. To support or facilitate communication in the mmWave band, the APs 102 and STAs 104 also may make use of various PHY layer enhancements, such as additional bandwidth modes, numerologies, tone plans, preamble designs, codebook designs, waveform designs, new PPDU formats or reuse of existing sub-7 GHz PPDU formats for mmWave frequencies. Particular RF and analog designs, such as RF front end designs, antenna integration designs, and conversion architecture designs, may be implemented in APs 102 and STAs 104 to support mmWave operation.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (for example, by generating a message integrity check (MIC) for one or more relevant fields).

Some APs and STAs (for example, the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Further, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as described above.

APs and STAs (for example, the AP 102 and the STAs 104 described with reference to FIG. 1) that include multiple antennas may support various diversity schemes. For example, spatial diversity may be used by one or both of a transmitting device (such as either AP 102 or STA 104) or a receiving device (such as an AP 102 or a STA 104) to increase the robustness of a transmission. For example, to implement a transmit diversity scheme, a transmitting device may transmit the same data redundantly over two or more antennas.

APs 102 and STAs 104 that include multiple antennas also may support space-time block coding (STBC). With STBC, a transmitting device also transmits multiple copies of a data stream across multiple antennas to exploit the various received versions of the data to increase the likelihood of decoding the correct data. More specifically, the data stream to be transmitted is encoded in blocks, which are distributed among the spaced antennas and across time. Generally, STBC can be used when the number N_{Tx} of transmit antennas exceeds the number N_{SS} of spatial streams. The N_{SS} spatial streams may be mapped to a number N_{STS} of space-time streams, which are mapped to N_{Tx} transmit chains.

APs 102 and STAs 104 that include multiple antennas also may support spatial multiplexing, which may be used to increase the spectral efficiency and the resultant throughput of a transmission. To implement spatial multiplexing, the transmitting device divides the data stream into a number N_{SS} of separate, independent spatial streams. The spatial streams are separately encoded and transmitted in parallel via the multiple N_{Tx} transmit antennas.

APs 102 and STAs 104 that include multiple antennas also may support beamforming. Beamforming generally refers to the steering of the energy of a transmission in the direction of a target receiver. Beamforming may be used both in a single-user (SU) context, for example, to improve a signal-to-noise ratio (SNR), as well as in a multi-user (MU) context, for example, to enable MU-MIMO transmissions (also referred to as spatial division multiple access (SDMA)). In the MU-MIMO context, beamforming may additionally or alternatively involve the nulling out of energy in the directions of other receiving devices. To perform SU beamforming or MU-MIMO, a transmitting device, referred to as the beamformer, transmits a signal from each of multiple antennas. The beamformer configures the amplitudes and phase shifts between the signals transmitted from the different antennas such that the signals add constructively along particular directions towards the intended receiver (referred to as the beamformee) or add destructively in other directions towards other devices to mitigate interference in a MU-MIMO context. The manner in which the beamformer configures the amplitudes and phase shifts depends on channel state information (CSI) associated with the wireless channels over which the beamformer intends to communicate with the beamformee.

To obtain the CSI necessary for beamforming, the beamformer may perform a channel sounding procedure with the beamformee. For example, the beamformer may transmit one or more sounding signals (for example, in the form of a null data packet (NDP)) to the beamformee. An NDP is a PPDU without any data field. The beamformee may perform measurements for each of the N_{Tx}×N_{Rx} sub-channels corresponding to all of the transmit antenna and receive antenna pairs associated with the sounding signal. The beamformee generates a feedback matrix associated with the channel measurements and, typically, compresses the feedback matrix before transmitting the feedback to the beamformer. The beamformer may generate a precoding (or “steering”) matrix for the beamformee associated with the feedback and use the steering matrix to precode the data streams to configure the amplitudes and phase shifts for subsequent transmissions to the beamformee. The beamformer may use the steering matrix to determine (for example, identify, detect, ascertain, calculate, or compute) how to transmit a signal on each of its antennas to perform beamforming. For example, the steering matrix may be indicative of a phase shift, or a power level, to use to transmit a respective signal on each of the beamformer's antennas.

When performing beamforming, the transmitting beamforming array gain is logarithmically proportional to the ratio of N_{Tx} to N_{SS}. As such, it is generally desirable, within other constraints, to increase the number N_{Tx} of transmit antennas when performing beamforming to increase the gain. It is also possible to more accurately direct transmissions or nulls by increasing the number of transmit antennas. This is especially advantageous in MU transmission contexts in which it is particularly important to reduce inter-user interference.

To increase an AP 102's spatial multiplexing capability, an AP 102 may need to support an increased number of spatial streams (such as up to 16 spatial streams). However, supporting additional spatial streams may result in increased CSI feedback overhead. Implicit CSI acquisition techniques may avoid CSI feedback overhead by taking advantage of the assumption that the UL and DL channels have reciprocal impulse responses (that is, that there is channel reciprocity). For example, the CSI feedback overhead may be reduced using an implicit channel sounding procedure such as an implicit beamforming report (BFR) technique (such as where STAs 104 transmit NDP sounding packets in the UL while the AP 102 measures the channel) because no BFRs are sent. Once the AP 102 receives the NDPs, it may implicitly assess the channels for each of the STAs 104 and use the channel assessments to configure steering matrices. In order to mitigate hardware mismatches that could break the channel reciprocity on the UL and DL (such as the baseband-to-RF and RF-to-baseband chains not being reciprocal), the AP 102 may implement a calibration method to compensate for the mismatch between the UL and the DL channels. For example, the AP 102 may select a reference antenna, transmit a pilot signal from each of its antennas, and estimate baseband-to-RF gain for each of the non-reference antennas relative to the reference antenna.

In some examples, multiple APs 102 may simultaneously transmit signaling or communications to a single STA 104 utilizing a distributed MU-MIMO scheme. Examples of such a distributed MU-MIMO transmission include coordinated beamforming (CBF) and joint transmission (JT). With CBF, signals (such as data streams) for a given STA 104 may be transmitted by only a single AP 102. However, the coverage areas of neighboring APs may overlap, and signals transmitted by a given AP 102 may reach the STAs in OBSSs associated with neighboring APs as OBSS signals. CBF allows multiple neighboring APs to transmit simultaneously while minimizing or avoiding interference, which may result in more opportunities for spatial reuse. More specifically, using CBF techniques, an AP 102 may beamform signals to in-BSS STAs 104 while forming nulls in the directions of STAs in OBSSs such that any signals received at an OBSS STA are of sufficiently low power to limit the interference at the STA. To accomplish this, an inter-BSS coordination set may be defined between the neighboring APs, which contains identifiers of all APs and STAs participating in CBF transmissions.

With JT, signals for a given STA 104 may be transmitted by multiple coordinated APs 102. For the multiple APs 102 to concurrently transmit data to a STA 104, the multiple APs 102 may all need a copy of the data to be transmitted to the STA 104. Accordingly, the APs 102 may need to exchange the data among each other for transmission to a STA 104. With JT, the combination of antennas of the multiple APs 102 transmitting to one or more STAs 104 may be considered as one large antenna array (which may be represented as a virtual antenna array) used for beamforming and transmitting signals. In combination with MU-MIMO techniques, the multiple antennas of the multiple APs 102 may be able to transmit data via multiple spatial streams. Accordingly, each STA 104 may receive data via one or more of the multiple spatial streams.

Some APs and STAs, such as, for example, the AP 102 and STAs 104 described with reference to FIG. 1, are capable of multi-link operation (MLO). For example, the AP 102 and STAs 104 may support MLO as defined in one or both of the IEEE 802.11be and 802.11bn standard amendments. An MLO-capable device may be referred to as a multi-link device (MLD). In some examples, MLO supports establishing multiple different communication links (such as a first link on the 2.4 GHz band, a second link on the 5 GHz band, a third link on the 6 GHz band, and a fourth link on the 60 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, for example, three independent lower MAC entities and three associated independent PHY entities for respective links in the 2.4 GHz, 5 GHz, and 6 GHz bands. This architecture may enable a single association process and security context. An AP MLD may include multiple APs 102 each configured to communicate on a respective communication link with a respective one of multiple STAs 104 of a non-AP MLD (also referred to as a “STA MLD”).

To support MLO techniques, an AP MLD and a STA MLD may exchange MLO capability information (such as supported aggregation types or supported frequency bands, among other information). In some examples, the exchange of information may occur via a beacon frame, a probe request frame, a probe response frame, an association request frame, an association response frame, another management frame, a dedicated action frame, or an operating mode indicator (OMI), among other examples. In some examples, an AP MLD may designate a specific channel of one link in one of the bands as an anchor channel on which it transmits beacons and other control or management frames periodically. In such examples, the AP MLD also may transmit shorter beacons (such as ones which may contain less information) on other links for discovery or other purposes.

MLDs may exchange packets on one or more of the communications links dynamically and, in some instances, concurrently. MLDs also may independently contend for access on each of the communication links, which achieves latency reduction by enabling the MLD to transmit its packets on the first communication link that becomes available. For example, “alternating multi-link” may refer to an MLO mode in which an MLD may listen on two or more different high-performance links and associated channels concurrently. In an alternating multi-link mode of operation, an MLD may alternate between use of two links to transmit portions of its traffic. Specifically, an MLD with buffered traffic may use the first link on which it wins contention and obtains a TXOP to transmit the traffic. While such an MLD may in some examples be capable of transmitting or receiving on only one communication link at any given time, having access opportunities via two different links enables the MLD to avoid congestion, reduce latency, and maintain throughput.

Multi-link aggregation (MLA) (which also may be referred to as carrier aggregation (CA)) is another MLO mode in which an MLD may simultaneously transmit or receive traffic to or from another MLD via multiple communication links in parallel such that utilization of available resources may be increased to achieve higher throughput. That is, during at least some duration of time, transmissions or portions of transmissions may occur over two or more communication links in parallel at the same time. In some examples, the parallel communication links may support synchronized transmissions. In some other examples, or during some other durations of time, transmissions over the communication links may be parallel, but not be synchronized or concurrent. Additionally, in some examples or durations of time, two or more of the communication links may be used for communications between MLDs in the same direction (such as all uplink or all downlink), while in some other examples or durations of time, two or more of the communication links may be used for communications in different directions (for example, one or more communication links may support uplink communications and one or more communication links may support downlink communications). In such examples, at least one of the MLDs may operate in a full duplex mode.

MLA may be packet-based or flow-based. For packet-based aggregation, frames of a single traffic flow (such as all traffic associated with a given traffic identifier (TID)) may be transmitted concurrently across multiple communication links. For flow-based aggregation, each traffic flow (such as all traffic associated with a given TID) may be transmitted using a single respective one of multiple communication links. As an example, a single STA MLD may access a web browser while streaming a video in parallel. Per the above example, the traffic associated with the web browser access may be communicated over a first communication link while the traffic associated with the video stream may be communicated over a second communication link in parallel (such that at least some of the data may be transmitted on the first channel concurrently with data transmitted on the second channel). In some other examples, MLA may be implemented with a hybrid of flow-based and packet-based aggregation. For example, an MLD may employ flow-based aggregation in situations in which multiple traffic flows are created and may employ packet-based aggregation in other situations. Switching among the MLA techniques or modes may additionally, or alternatively, be associated with other metrics (such as a time of day, traffic load within the network, or battery power for a wireless communication device, among other factors or considerations).

Other MLO techniques may be associated with traffic steering and QoS characterization, which may achieve latency reduction and other QoS enhancements by mapping traffic flows having different latency or other requirements to different links. For example, traffic with low latency requirements may be mapped to communication links operating in the 6 GHz band and more latency-tolerant flows may be mapped to communication links operating in the 2.4 GHz or 5 GHz bands. Such an operation, referred to as TID-to-Link mapping (TTLM), may enable two MLDs to negotiate mapping of certain traffic flows in the DL direction or the UL direction or both directions to one or more set of communication links set up between them. In some examples, an AP MLD may advertise a global TTLM that applies to all associated non-AP MLDs. A communication link that has no TIDs mapped to it in either direction is referred to as a disabled link. An enabled link has at least one TID mapped to it in at least one direction.

In some examples, an MLD may include multiple radios and each communication link associated with the MLD may be associated with a respective radio of the MLD. Each radio may include one or more of its own transmit/receive (Tx/Rx) chains, include or be coupled with one or more of its own physical antennas or shared antennas, and include signal processing components, among other components. An MLD with multiple radios that may be used concurrently for MLO may be referred to as a multi-link multi-radio (MLMR) MLD. Some MLMR MLDs may further be capable of an enhanced MLMR (eMLMR) mode of operation, in which the MLD may be capable of dynamically switching radio resources (such as antennas or RF frontends) between multiple communication links (for example, switching from using radio resources for one communication link to using the radio resources for another communication link) to enable higher transmission and reception using higher capacity on a given communication link. In this eMLMR mode of operation, MLDs may be able to move Tx/Rx radio resources from one communication link to another link, thereby increasing the spatial stream capability of the other communication link. For example, if a non-AP MLD includes four or more STAs, the STAs associated with the eMLMR links may “pool” their antennas so that each of the STAs can utilize the antennas of other STAs when transmitting or receiving on one of the eMLMR links.

Other MLDs may have more limited capabilities and not include multiple radios. An MLD with only a single radio that is shared for multiple communication links may be referred to as a multi-link single radio (MLSR) MLD. Control frames may be exchanged between MLDs before initiating data or management frame exchanges between the MLDs in cases in which at least one of the MLDs is operating as an MLSR MLD. Because an MLD operating in the MLSR mode is limited to a single radio, it cannot use multiple communication links simultaneously and may instead listen to (for example, monitor), transmit or receive on only a single communication link at any given time. An MLSR MLD may instead switch between different bands in a TDM manner. In contrast, some MLSR MLDs may further be capable of an enhanced MLSR (eMLSR) mode of operation, in which the MLD can concurrently listen on multiple links for specific types of packets, such as buffer status report poll (BSRP) frames or multi-user (MU) request-to-send (RTS) (MU-RTS) frames. Although an MLD operating in the eMLSR mode can still transmit or receive on only one of the links at any given time, it may be able to dynamically switch between bands, resulting in improvements in both latency and throughput. For example, when the STAs of a non-AP MLD may detect a BSRP frame on their respective communication links, the non-AP MLD may tune all of its antennas to the communication link on which the BSRP frame is detected. By contrast, a non-AP MLD operating in the MLSR mode can only listen to, and transmit or receive on, one communication link at any given time.

An MLD that is capable of simultaneous transmission and reception on multiple communication links may be referred to as a simultaneous transmission and reception (STR) device. In a STR-capable MLD, a radio associated with a communication link can independently transmit or receive frames on that communication link without interfering with, or without being interfered with by, the operation of another radio associated with another communication link of the MLD. For example, an MLD with a suitable filter may simultaneously transmit on a 2.4 GHz band and receive on a 5 GHz band, or vice versa, or simultaneously transmit on the 5 GHz band and receive on the 6 GHz band, or vice versa, and as such, be considered a STR device for the respective paired communication links. Such an STR-capable MLD may generally be an AP MLD or a higher-end STA MLD having a higher performance filter. An MLD that is not capable of simultaneous transmission and reception on multiple communication links may be referred to as a non-STR (NSTR) device. A radio associated with a given communication link in an NSTR device may experience interference when there is a transmission on another communication link of the NSTR device. For example, an MLD with a standard filter may not be able to simultaneously transmit on a 5 GHz band and receive on a 6 GHz band, or vice versa, and as such, may be considered a NSTR device for those two communication links.

In some wireless communication systems, an MLD may include multiple non-collocated entities. For example, an AP MLD may include non-collocated AP devices and a STA MLD may include non-collocated STA devices. In examples in which an AP MLD includes multiple non-collocated AP devices, a single mobility domain (SMD) entity may refer to a logical entity that controls the associated non-collocated APs. A non-AP STA (such as a non-MLD non-AP STA or a non-AP MLD that includes one or more associated non-AP STAs) may associate with the SMD entity via one of its constituent APs and may seamlessly roam (such as without requiring reassociation) between the APs associated with the SMD entity. The SMD entity also may maintain other context (such as security and Block ACK) for non-AP STAs associated with it.

The afore-mentioned and related MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the “on” time of a modem, which may benefit a wireless communication device in terms of power consumption. Another benefit of MLO is the increased multiplexing opportunities in the case of a single BSS. For example, MLA may increase the number of users per multiplexed transmission served by the multi-link AP MLD.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (for example, APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

In certain aspects, the computer-readable medium/memory of the AP 102 or STA 104 stores code for performing a sector level sweep (SLS) (such as an example of means for performing SLS), code for obtaining an indication of a set of N best transmit beams associated with the SLS (such as an example of means for obtaining an indication), code for performing a beam refinement phase (BRP) associated with the indication (such as an example of means for performing BRP), code for operating in an omni receive mode (such as an example of means for operating in omni receive mode), code for identifying a set of N best transmit beams (such as an example of means for identifying), code for outputting an indication (such as an example of means for outputting), code for obtaining an indication of blockage (such as an example of means for obtaining blockage indication), code for outputting RTS frames (such as an example of means for outputting RTS frames), code for obtaining CTS frames (such as an example of means for obtaining CTS frames), code for communicating using transmit beams (such as an example of means for communicating), code for switching between transmit beams (such as an example of means for switching), code for ranking beam pairs (such as an example of means for ranking), code for detecting removal of blockage (such as an example of means for detecting), and code for outputting communications on alternative transmit beams (such as an example of means for outputting communications).

In certain aspects, the processor of the AP 102 or STA 104 has circuitry configured to implement the code stored in the computer-readable medium/memory. The processor includes circuitry for performing SLS (such as an example of means for performing SLS), circuitry for obtaining an indication of a set of N best transmit beams associated with the SLS (such as an example of means for obtaining an indication), circuitry for performing BRP associated with the indication (such as an example of means for performing BRP), circuitry for operating in omni receive mode (such as an example of means for operating in omni receive mode), circuitry for identifying a set of N best transmit beams (such as an example of means for identifying), circuitry for outputting an indication (such as an example of means for outputting), circuitry for obtaining an indication of blockage (such as an example of means for obtaining blockage indication), circuitry for outputting RTS frames (such as an example of means for outputting RTS frames), circuitry for obtaining CTS frames (such as an example of means for obtaining CTS frames), circuitry for communicating using transmit beams (such as an example of means for communicating), circuitry for switching between transmit beams (such as an example of means for switching), circuitry for ranking beam pairs (such as an example of means for ranking), circuitry for detecting removal of blockage (such as an example of means for detecting), and circuitry for outputting communications on alternative transmit beams (such as an example of means for outputting communications).

The transceiver of the AP 102 or STA 104 may provide a means for receiving information such as packets, user data, or control information associated with various information channels (such as control channels, data channels, etc.). Information may be passed on to other components of the device. The transceiver may provide means for transmitting signals generated by other components of the device.

In some cases, rather than actually transmitting a frame, a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception. In some cases, the interface to output a frame for transmission and the interface to obtain a frame (which may be referred to as first and second interfaces herein) may be the same interface.

Means for performing SLS, means for obtaining an indication of best transmit beams associated with the SLS, means for performing BRP associated with the indication, means for operating in omni receive mode, means for identifying best transmit beams, means for outputting an indication, means for obtaining blockage indication, means for outputting RTS frames, means for obtaining CTS frames, means for communicating using transmit beams, means for switching between transmit beams, means for ranking beam pairs, means for detecting removal of blockage, and means for outputting communications on alternative transmit beams may include any of the various processors and/or memories of the AP 102 or STA 104. Means for obtaining and/or means for outputting may include any of the various processors, memories, and/or transceivers of the AP 102 or STA 104.

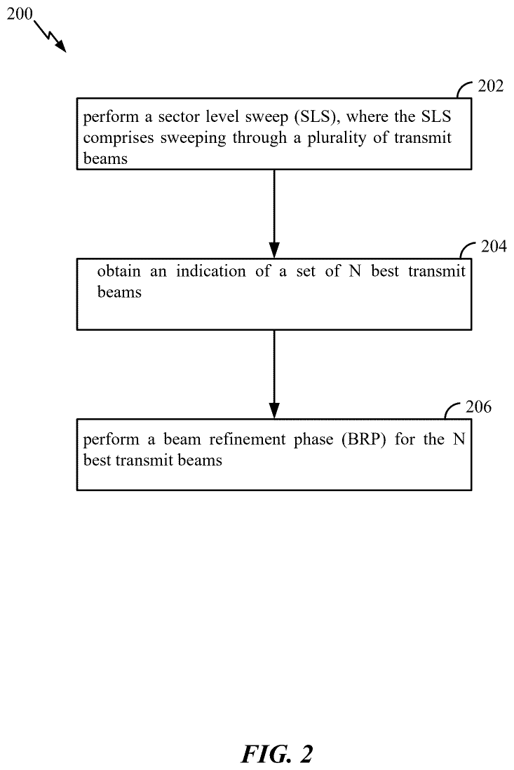

FIG. 2 shows a flowchart illustrating an example method 200 performable by or at a wireless communication device that supports adaptive beam management for millimeter wave wireless communication. The operations of method 200 may be implemented by a wireless communication device or its components as described herein. In some examples, method 200 may be performed by a wireless communication device such as one of the APs 102 or STAs 104 described with reference to FIG. 1 functioning as an initiator device. When functioning as an initiator device, the device performs the sector level sweep (SLS), obtains feedback on the best transmit beams, and conducts the beam refinement phase (BRP). This process enables the initiator to establish and maintain optimal communication paths with its peer device, even in dynamic environments prone to beam blockages.

At step 202, the wireless communication device performs a sector level sweep (SLS), where the SLS comprises sweeping through a plurality of transmit beams. In certain aspects, this step may involve the device systematically transmitting signals across various directional beams to identify potential communication paths.

At step 204, the wireless communication device obtains an indication of a set of N best transmit beams, where N is an integer greater than one. In some aspects, this step may include obtaining a signal quality indicator for each of the N best transmit beams or obtaining a signal quality difference between two or more of the N best transmit beams.

At step 206, the wireless communication device performs a beam refinement phase (BRP) for the N best transmit beams to identify a corresponding set of best receive beams. In certain aspects, this step involves a more detailed examination of the N best transmit beams identified in step 204. In some aspects, following the BRP, the wireless communication device may obtain an indication of a set of best transmit-receive beam pairs. This indication may be based on at least one of the SLS, the BRP, or a neighbor-network report, allowing the device to compile a comprehensive ranking of beam pairs considering multiple sources of information.

The method 200 may also include steps to handle dynamic channel conditions. For instance, the wireless communication device may obtain an indication of a blockage associated with a first transmit beam in the set of N best transmit beams. In response, the device may output, for transmission, a request-to-send (RTS) frame using a second transmit beam in the set of N best transmit beams, with the RTS frame including an indication of the second transmit beam being used.

In some implementations, the wireless communication device may detect the removal of a blockage. Upon detecting such removal, the device may output, for transmission, an RTS frame using the previously blocked transmit beam, including an indication of this beam in the RTS frame. If a clear-to-send (CTS) frame is received in response, the device may resume communication using this transmit beam.

Further, the wireless communication device may implement adaptive beam switching techniques. This may involve storing data indicating signal quality of the set of N best transmit beams and switching between transmit beams in the set based on this data or a configured switch time. The configured switch time might be determined based on various factors such as the device's location, quality of service (QoS) requirements, or historical telemetry data.

In scenarios where multiple beams are blocked, the wireless communication device may obtain an indication of blockage associated with both a first and a second transmit beam in the set of N best transmit beams. In such cases, the device may select a third best transmit beam from the set for communication, based on the detected blockages.

By implementing method 200, the wireless communication device can maintain a diverse set of viable communication paths for adaptation to changing channel conditions. The ability to switch between multiple ranked beams, detect and respond to blockages, and adapt based on various operational parameters allows for resilient wireless communication in challenging environments.

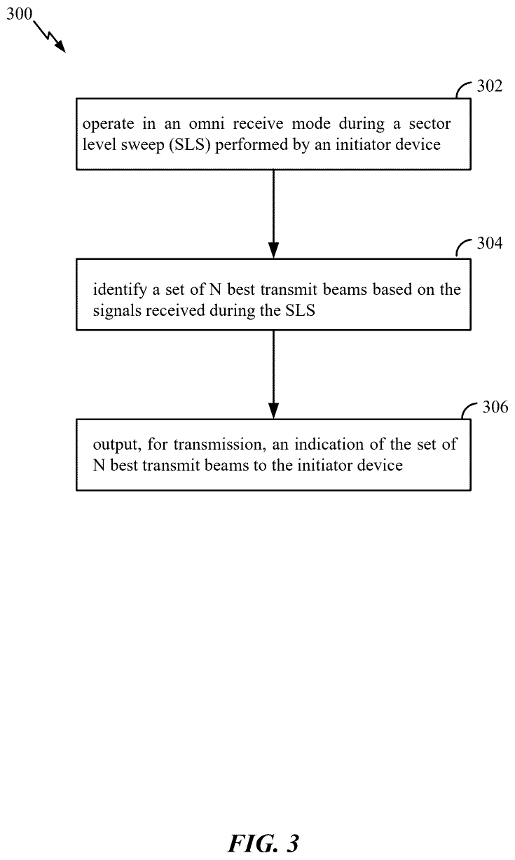

FIG. 3 shows a flowchart illustrating an example method 300 performable by or at a wireless communication device acting as a responder device in an adaptive beam management scenario. The operations of method 300 may be implemented by a wireless communication device such as the AP 102 or STA 104 described with reference to FIG. 1, when functioning as a responder. When functioning as a responder, the device may operate in an omni-directional receive mode during the SLS phase conducted by the initiator, captures and processes signals from all possible directions, identifies the set of N best transmit beams based on signal quality metrics, and provides feedback to the initiator about these optimal beams. The responder can then participate in the BRP process initiated by the initiator, helping to refine and establish the best transmit-receive beam pairs. Additionally, the responder device plays a role in adapting to dynamic channel conditions by responding to changes in beam selection initiated by the initiator, such as when dealing with beam blockages. It does this by adjusting its receive configuration based on the information received in RTS frames and responding with appropriate CTS frames. This adaptive behavior of the responder device contributes to maintaining robust millimeter wave communication links.

At step 302, the wireless communication device operates in an omni receive mode during a sector level sweep (SLS) performed by an initiator device. In certain aspects, this step involves the responder device listening for transmissions across various directional beams swept by the initiator device. This omni receive mode allows the responder to capture signals from all possible directions during the SLS.

At step 304, based on the signals received during the SLS, the wireless communication device identifies a set of N best transmit beams, where N is an integer greater than one. In certain aspects, this step may involve measuring and comparing signal qualities (such as signal-to-noise ratio or received signal strength) for each received beam to determine the top N performers.

At step 306, the wireless communication device outputs, for transmission, an indication of the set of N best transmit beams to the initiator device. This feedback allows the initiator to focus on promising beam directions for subsequent communications.

In some aspects, the wireless communication device may perform additional operations to refine and utilize the beam information. For instance, at step 308, the device may rank a set of best transmit-receive beam pairs. This ranking may be based on both the SLS and/or a subsequent beam refinement phase (BRP) procedure. This provides an assessment of bidirectional link quality for each beam pair.

The wireless communication device may include additional information in its feedback to the initiator. For example, at step 310, the device may include in the indication output at step 306 a signal quality indicator for each of the N best transmit beams, or a quantized difference in signal quality relative to the best transmit beam among the N best transmit beams. This can help the initiator make more informed decisions about beam selection and management.

Method 300 may also include steps for handling dynamic channel conditions and beam blockages. The wireless communication device may obtain a request-to-send (RTS) frame from the initiator that includes an indication of a selected transmit beam. In response, the device outputs, for transmission, a clear-to-send (CTS) frame using a receive beam corresponding to the selected transmit beam. This RTS/CTS exchange helps establish viable communication paths.

In scenarios where beam blockages occur, the wireless communication device may implement adaptive techniques. For instance, the device may obtain an indication of a blockage associated with at least one of a first transmit beam and a second transmit beam in the set of N best transmit beams. In response, the device selects a third best transmit beam from the set of N best transmit beams for communication based on the detected blockages.

Method 300 may also include steps for handling changes in the initiator's beam selection. The wireless communication device may obtain a second RTS frame that includes an indication of a second selected transmit beam, different from the initially selected transmit beam. In response, the device outputs, for transmission, a second CTS frame using a receive beam corresponding to this second selected transmit beam.

Finally, method 300 may include steps for adapting to the removal of beam blockages. The wireless communication device may obtain an indication of a removal of a blockage associated with the initially selected transmit beam. In response, the device outputs, for transmission, a third CTS frame using a receive beam corresponding to the selected transmit beam for which the removal of the blockage is detected. This allows the communication link to revert to optimal paths when blockages are cleared.

According to method 300, the wireless communication device acting as a responder can participate in maintaining robust communication paths for adaptation to changing channel conditions in millimeter wave communications. The ability to provide meaningful feedback, respond to changing beam selections, and adapt to blockages allows efficient wireless communication in challenging environments.

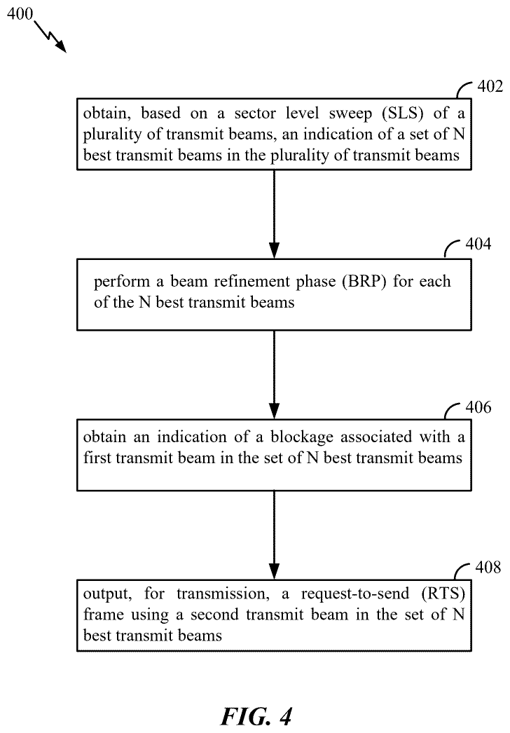

FIG. 4 shows a flowchart illustrating an example method 400 performable by or at a wireless communication device for adaptive beam management in millimeter wave communication. The operations of method 400 may be implemented by a wireless communication device such as the AP 102 or STA 104 described with reference to FIG. 1.

At step 402, the wireless communication device obtains, based on a sector level sweep (SLS) of a plurality of transmit beams, an indication of a set of N best transmit beams in the plurality of transmit beams, where N is an integer greater than one. In certain aspects, this step involves receiving feedback from a peer device that has evaluated the signal quality of the transmit beams swept during the SLS.

At step 404, the wireless communication device performs a beam refinement phase (BRP) for each of the N best transmit beams. In some implementations, this step may involve a more detailed examination of the N best transmit beams identified during the SLS, allowing the device to determine optimal receive beam configurations for each transmit direction.

At step 406, the wireless communication device obtains an indication of a blockage associated with a first transmit beam in the set of N best transmit beams. This indication may come from various sources, such as failed transmission attempts or feedback from the peer device.

At step 408, in response to the detected blockage, the wireless communication device outputs, for transmission, a request-to-send (RTS) frame using a second transmit beam in the set of N best transmit beams. Importantly, this RTS frame includes an indication of the second transmit beam being used. This allows the peer device to adjust its receive beam accordingly.

Method 400 may also include steps for adapting to the removal of beam blockages. The wireless communication device may detect a removal of the blockage associated with the first transmit beam. This detection might be based on periodic checks or other environmental sensing mechanisms.

Following the detection of the blockage removal, the wireless communication device outputs, for transmission, an RTS frame using the first transmit beam. This allows the device to revert to the previously blocked beam.

Finally, the wireless communication device obtains a clear-to-send (CTS) frame in response to the RTS frame using the first transmit beam. This confirms that the peer device has successfully received the RTS on the previously blocked beam and is ready to resume communication on this path.

According to method 400, wireless communication device can maintain communication paths in the presence of dynamic blockages. The ability to switch between multiple beams and detect and respond to the onset and removal of blockages allows for efficient wireless communication in challenging millimeter wave environments.

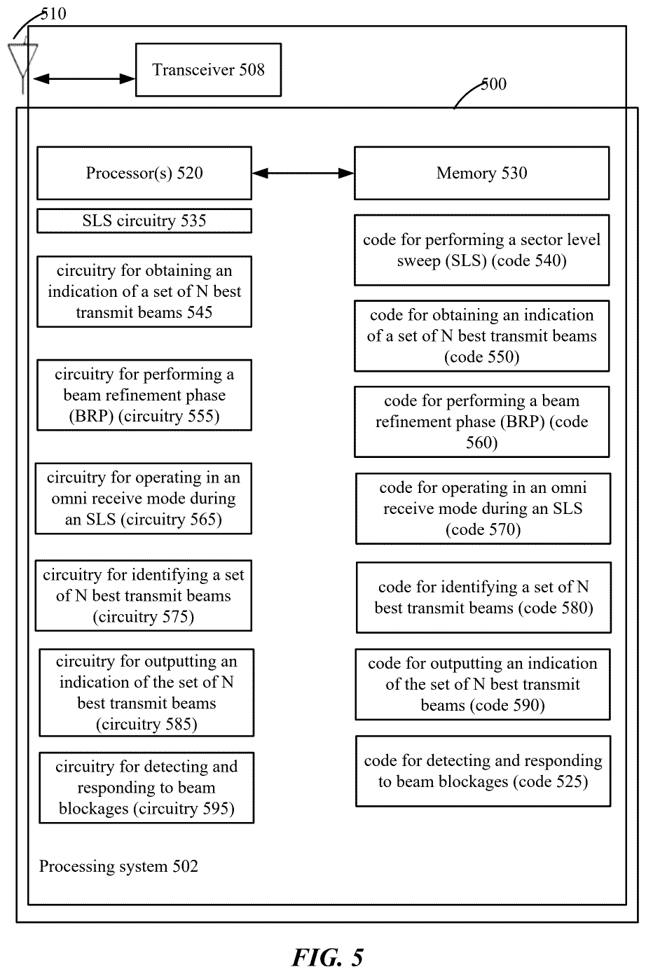

FIG. 5 is a block diagram of an example wireless communication device 500 that supports adaptive beam management for millimeter wave wireless communication according to one or more aspects. In some examples, the wireless communication device 500 is configured to perform the methods 200, 300, and 400 described with reference to FIGS. 2, 3, and 4, respectively. The wireless communication device 500 may include one or more chips, SoCs, chipsets, packages, components or devices that individually or collectively constitute or include a processing system. The processing system may interface with other components of the wireless communication device 500, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the device 500 may transmit the information output from the chip. In such an example, the second interface may refer to an interface between the processing system of the chip and a reception component, such that the device 500 may receive information that is passed to the processing system. In some such examples, the first interface also may obtain information, such as from the transmission component, and the second interface also may output information, such as to the reception component. This configuration allows the wireless communication device 500 to efficiently perform the roles of both initiator and responder in adaptive beam management scenarios, switching between these roles as needed to maintain optimal millimeter wave communication links.

Device 500 includes processing system 502 coupled to transceiver 508 (e.g., a transmitter and/or a receiver). Transceiver 508 is configured to transmit and receive signals for device 500 via antenna 510, such as the various signals as described herein. Processing system 502 may be configured to perform processing functions for device 500, including processing signals received and/or to be transmitted by device 500.

The processing system of the wireless communication device 500 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein, including those related to adaptive beam management for millimeter wave wireless communication. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein, including those related to acting as an initiator or responder in adaptive beam management scenarios. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE 802.11 compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 500 can be configurable or configured for use in an AP, such as the AP 102 described with reference to FIG. 1. In some other examples, the wireless communication device 500 can be configurable or configured for use in a STA, such as the STA 104 described with reference to FIG. 1. The wireless communication device 500 is capable of transmitting and receiving wireless communications in the form of, for example, wireless packets. For example, the wireless communication device 500 can be configurable or configured to transmit and receive packets in the form of physical layer PPDUs and MPDUs conforming to one or more of the IEEE 802.11 family of wireless communication protocol standards, including those related to millimeter wave communications. In some other examples, the wireless communication device 500 can be configurable or configured to transmit and receive signals and communications conforming to one or more 3GPP specifications including those for 5G NR or 6G. In some examples, the wireless communication device 500 also includes or can be coupled with one or more application processors which may be further coupled with one or more other memories. In some examples, when configured as an AP, the wireless communication device 500 further includes at least one external network interface coupled with the processing system that enables communication with a core network or backhaul network that enables the wireless communication device 500 to gain access to external networks including the Internet.

Processing system 502 includes one or more processors 520. The one or more processors 520 are coupled to computer-readable medium/memory 530 via one or more buses. Computer-readable medium/memory 530 is configured to store instructions (e.g., computer-executable code, processor-executable code) that when executed by the one or more processors 520, cause the one or more processors 520 to perform methods 200, 300, and 400 described with respect to FIGS. 2, 3, and 4, or any aspect related to them.

Device 500 includes circuitry for performing a sector level sweep (SLS) (circuitry 535). Device 500 also includes, stored in computer-readable medium/memory 530, code for performing a sector level sweep (SLS) (code 540).

Device 500 includes circuitry for obtaining an indication of a set of N best transmit beams (circuitry 545). Device 500 also includes, stored in computer-readable medium/memory 530, code for obtaining an indication of a set of N best transmit beams (code 550).

Device 500 includes circuitry for performing a beam refinement phase (BRP) (circuitry 555). Device 500 also includes, stored in computer-readable medium/memory 530, code for performing a beam refinement phase (BRP) (code 560).

Device 500 includes circuitry for operating in an omni receive mode during an SLS (circuitry 565). Device 500 also includes, stored in computer-readable medium/memory 530, code for operating in an omni receive mode during an SLS (code 570).

Device 500 includes circuitry for identifying a set of N best transmit beams (circuitry 575). Device 500 also includes, stored in computer-readable medium/memory 530, code for identifying a set of N best transmit beams (code 580).

Device 500 includes circuitry for outputting an indication of the set of N best transmit beams (circuitry 585). Device 500 also includes, stored in computer-readable medium/memory 530, code for outputting an indication of the set of N best transmit beams (code 590).

Device 500 includes circuitry for detecting and responding to beam blockages (circuitry 595). Device 500 also includes, stored in computer-readable medium/memory 530, code for detecting and responding to beam blockages (code 525).

Device 500 also includes a beam management manager, which may support adaptive beam management for millimeter wave wireless communications in accordance with examples as disclosed herein. Its features include implementing the initiator and responder roles as described in methods 200 and 300, as well as the general beam management techniques described in method 400.

Various components of device 500 may provide means for performing methods 200, 300, and 400 described with respect to FIGS. 2, 3, and 4, or any aspect related to them. For example, means for transmitting, sending, or outputting for transmission may include transceiver 508 and antenna 510 of device 500. Means for receiving or obtaining may include transceiver 508 and antenna 510 of device 500.

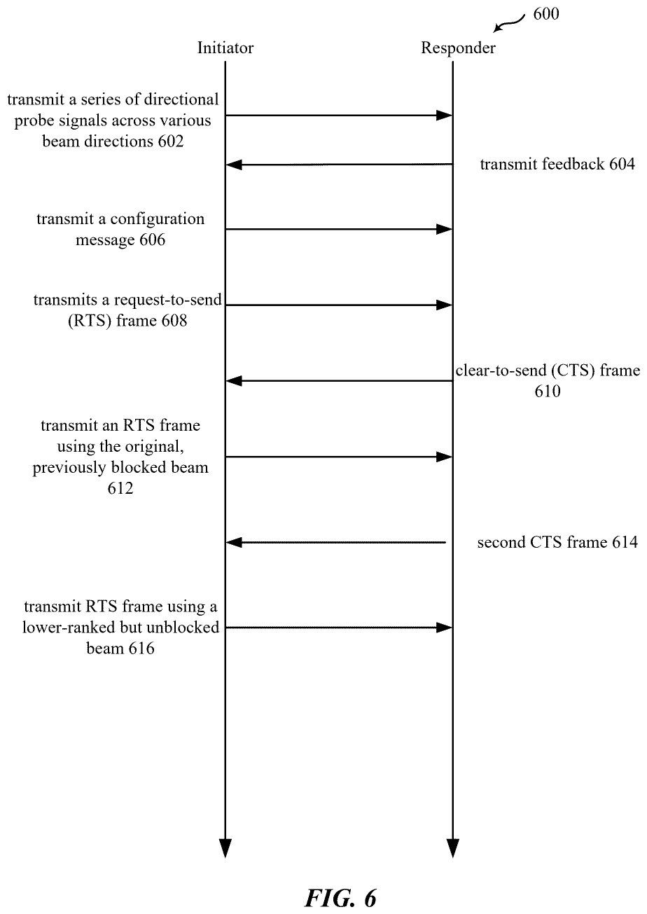

FIG. 6 is a signaling diagram illustrating an example process 600 that supports adaptive beam management for millimeter wave wireless communication according to one or more aspects. As shown in FIG. 6, process 600 includes communication between an initiator device and a responder device. These devices may be examples of AP 102 or STA 104 as described earlier, with either capable of functioning as the initiator or responder. The devices may communicate via a wireless millimeter wave link, which may include both uplink and downlink communications.

The initiator device performs a sector level sweep (SLS) by, at 602, transmitting a series of directional probe signals across various beam directions. The responder device operates in an omni-directional receive mode during this SLS phase, capturing signals from all possible directions.

The responder device processes the received probe signals and determines an ordered set of N best transmit beams, where N is an integer greater than one. This determination may be based on signal quality metrics such as signal-to-noise ratio (SNR) or received signal strength indicator (RSSI) for each received beam.

At 604, the responder device transmits feedback to the initiator device. This feedback includes an indication of the ordered set of N best transmit beams. The feedback may also include additional information such as signal quality indicators for each of the N best transmit beams, quantized differences in signal quality relative to the best transmit beam among the N best transmit beams, and information about the responder's filtering capabilities, if applicable.

The initiator device receives the feedback and proceeds to perform a beam refinement phase (BRP) for each of the N best transmit beams identified by the responder. This BRP process allows for more precise beam alignment and may involve additional signaling between the initiator and responder to determine optimal receive beam configurations for each promising transmit direction.

Based on the results of the BRP, either or both of the initiator and responder devices establish a ranked list of best transmit-receive beam pairs for communication. This ranked list includes information about the corresponding SNR/RSSI for each beam pair, allowing for informed decisions in subsequent communications.

At 606, the initiator device may transmit a configuration message to the responder device. This message may include a frequency resource configuration for subsequent communications, a time resource configuration for subsequent communications, and parameters for adaptive beam switching, such as configured switch times or criteria.

Regular communication begins using the established beam pairs. However, the process includes mechanisms for handling dynamic channel conditions and blockages.

If the initiator device detects a blockage associated with the primary transmit beam, it switches to an alternative beam from the ranked list. At 608, the initiator then transmits a request-to-send (RTS) frame using this alternative beam. Importantly, this RTS frame includes an indication of the specific beam being used, allowing the responder to adjust accordingly.

The responder device receives the RTS frame, recognizes the beam change, and responds, at 610 with a clear-to-send (CTS) frame using the corresponding receive beam.

Communication continues using the alternative beam pair. Both devices may implement adaptive beam switching techniques, which could involve storing and updating data indicating signal quality of the set of N best transmit beams, switching between transmit beams based on this data or configured switch times, and adjusting switch times based on factors such as device location, quality of service (QoS) requirements, or historical telemetry data.

The initiator device may subsequently detect the removal of the original blockage. In this case, at 612, it may transmit an RTS frame using the original, previously blocked beam. This RTS frame again includes an indication of the beam being used. If the responder device successfully receives this RTS on the original beam, it responds with a CTS frame at 614, allowing communication to resume on the original, potentially superior beam pair.

Both devices may periodically or adaptively update their ranked list of beam pairs. This could involve repeating the SLS and BRP procedures with the devices switching initiator/responder roles, incorporating information from neighbor-network reports, if available, and adjusting rankings based on observed performance during actual data transmission.

The process 600 may also include additional signaling to handle scenarios where multiple beams are blocked. If the initiator device detects blockages on multiple preferred beams, it may select a lower-ranked but unblocked beam from its list. The initiator then transmits an RTS frame using this beam at 616, including an indication of the beam in use. The responder device, upon receiving an RTS indicating use of a lower-ranked beam, may adjust its receive configuration accordingly and respond with a CTS frame using the corresponding receive beam.

Throughout process 600, both the initiator and responder devices may implement energy-aware beam and filter selection strategies as well. Either device may transmit indications of its current energy status. This could be done periodically or in response to specific events or thresholds. Upon receiving energy status information, the peer device may adjust its beam selection or suggest beam changes to optimize power consumption while maintaining communication quality.

The adaptive beam management process 600 enables the initiator and responder devices to maintain high-quality millimeter wave links even in challenging environments. By maintaining multiple beam options, adapting to blockages, and managing energy consumption, process 600 can reduce link outages, improve system performance, and enhance the user experience in wireless applications such as XR, gaming, and wireless display technologies.

Implementation examples are described in the following numbered clauses:

Clause 1: A method for wireless communication at a wireless node, the method comprising: performing a sector level sweep (SLS), where the SLS includes sweeping through a plurality of transmit beams; obtaining an indication of a set of N best transmit beams, where N is an integer greater than one; and performing a beam refinement phase (BRP) for the N best transmit beams to identify a corresponding set of best receive beams.

Clause 2: The method of Clause 1, further comprising: obtaining an indication of a set of best transmit-receive beam pairs based on at least one of the SLS, the BRP, or a neighbor-network report.

Clause 3: The method of Clause 1, further comprising: obtaining a signal quality indicator for each of the N best transmit beams; or obtaining a signal quality difference between two or more of the N best transmit beams.

Clause 4: The method of Clause 1, further comprising: obtaining an indication of a blockage associated with a first transmit beam in the set of N best transmit beams; and outputting, for transmission, a request-to-send (RTS) frame using a second transmit beam in the set of N best transmit beams, the RTS frame including an indication of the second transmit beam.

Clause 5: The method of Clause 4, further comprising: obtaining an indication of a removal of the blockage associated with the first transmit beam; outputting, for transmission, an RTS frame using the first transmit beam, the RTS frame including an indication of the first transmit beam; and obtaining a clear-to-send (CTS) frame after the RTS frame was output for transmission.

Clause 6: The method of Clause 5, further comprising: communicating using the first transmit beam after obtaining the CTS frame.

Clause 7: The method of Clause 1, further comprising: obtaining data indicating a signal quality of the set of N best transmit beams; and switching between transmit beams in the set of N best transmit beams based on at least one of the data or a configured switch time.

Clause 8: The method of Clause 7, wherein the configured switch time is based on at least one of: location of the wireless node; a quality of service (QoS) requirement; or telemetry data.

Clause 9: The method of Clause 1, further comprising: obtaining an indication of a blockage associated with a first transmit beam and a second transmit beam in the set of N best transmit beams; and selecting a third best transmit beam from the set of N best transmit beams for communication based on the blockage.

Clause 10: The method of Clause 4, further comprising: obtaining an indication of a blockage associated with the second transmit beam; and outputting, for transmission, a second RTS frame using a third transmit beam in the set of N best transmit beams, the second RTS frame including an indication of the third transmit beam.

Clause 11: The method of Clause 10, further comprising: obtaining an indication of a removal of the blockage associated with at least one of the first transmit beam or the second transmit beam; and outputting, for transmission, an RTS frame using the at least one of the first transmit beam or the second transmit beam for which the removal of the blockage was detected.

Clause 12: A method for wireless communication at a wireless node, the method comprising: operating in an omni receive mode during a sector level sweep (SLS), wherein the operation includes sweeping through a plurality of transmit beams; identifying, based on the operation, a set of N best transmit beams, where N is an integer greater than one; outputting, for transmission, an indication of the set of N best transmit beams.

Clause 13: The method of Clause 12, further comprising: ranking a set of best transmit-receive beam pairs, where the rank is based on the SLS and BRP.

Clause 14: The method of Clause 12, wherein the indication further includes at least one of: a signal quality indicator for each of the N best transmit beams; or a quantized difference in signal quality relative to a best transmit beam among the N best transmit beams.

Clause 15: The method of Clause 12, further comprising: obtaining a request-to-send (RTS) frame that includes an indication of a selected transmit beam; and outputting, for transmission, a clear-to-send (CTS) frame using a receive beam corresponding to the selected transmit beam.

Clause 16: The method of Clause 12, further comprising: obtaining an indication of a blockage associated with a first transmit beam and a second transmit beam in the set of N best transmit beams; and selecting a third best transmit beam from the set of N best transmit beams for communication based on the blockage.

Clause 17: The method of Clause 16, further comprising: obtaining a second RTS frame that includes an indication of a second selected transmit beam, the second selected transmit beam being different from the selected transmit beam; and outputting, for transmission, a second CTS frame using a receive beam corresponding to the second selected transmit beam.

Clause 18: The method of Clause 16, further comprising: obtaining an indication of a removal of a blockage associated with the selected transmit beam; and outputting, for transmission, a third CTS frame using a receive beam corresponding to the selected transmit beam for which the removal of the blockage is detected.

Clause 19: A method for wireless communication at a wireless node, the method comprising: obtaining, based on a sector level sweep (SLS) of a plurality of transmit beams, an indication of a set of N best transmit beams in the plurality of transmit beams, where N is an integer greater than one; performing a beam refinement phase (BRP) for each of the N best transmit beams; obtaining an indication of a blockage associated with a first transmit beam in the set of N best transmit beams; and outputting, for transmission, a request-to-send (RTS) frame using a second transmit beam in the set of N best transmit beams, the RTS frame including an indication of the second transmit beam.

Clause 20: The method of Clause 19, further comprising: detecting a removal of the blockage associated with the first transmit beam; outputting, for transmission, an RTS frame using the first transmit beam; and obtaining a clear-to-send (CTS) frame after outputting the RTS frame.

Clause 21: An apparatus, including: at least one memory including executable instructions; and at least one processor configured to execute the executable instructions and cause the apparatus to perform a method in accordance with any combination of Clauses 1-20.

Clause 22: An apparatus, including means for performing a method in accordance with any combination of Clauses 1-20.

Clause 23: A non-transitory computer-readable medium including executable instructions that, when executed by at least one processor of an apparatus, cause the apparatus to perform a method in accordance with any combination of Clauses 1-21.

Clause 24: A computer program product embodied on a computer-readable storage medium including code for performing a method in accordance with any combination of Clauses 1-20.

Clause 25: An STA, including: at least one transceiver; at least one memory including instructions; and one or more processors, individually or collectively, configured to cause the network node to perform the method of clauses 1-12, where the at least one transceiver is configured to at least receive the indication of the set of N best transmit beams.

Clause 26: An STA, including: at least one transceiver; at least one memory including instructions; and one or more processors, individually or collectively, configured to cause the network node to perform the method of clauses 13-19, where the at least one transceiver is configured to at least transmit the indication of the set of N best transmit beams.

Clause 27: An STA, including: at least one transceiver; at least one memory including instructions; and one or more processors, individually or collectively, configured to cause the network node to perform the method of clause 20, where the at least one transceiver is configured to at least receive the indication of the set of N best transmit beams, receive the indication of the blockage, and transmit the request-to-send (RTS) frame via the second transmit beam.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Further, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. An apparatus for wireless communication, comprising:
at least one memory comprising computer-executable instructions; and
a processing system that includes processor circuitry and memory circuitry that stores code, the processing system configured to cause the apparatus to:
perform a sector level sweep (SLS), wherein the performance comprises sweeping through a plurality of transmit beams;
obtain an indication of a set of N best transmit beams associated with the SLS, where N is an integer greater than one; and
perform a beam refinement phase (BRP) associated with the indication for the N best transmit beams.

2. The apparatus of claim 1, wherein the processing system is further configured to cause the apparatus to:
obtain an indication of a set of best transmit-receive beam pairs associated with at least one of the SLS, the BRP, or a neighbor-network report.

3. The apparatus of claim 1, wherein the processing system is further configured to cause the apparatus to:
obtain a signal quality indicator for each of the N best transmit beams; or
obtain a signal quality difference between two or more of the N best transmit beams.

4. The apparatus of claim 1, wherein the processing system is further configured to cause the apparatus to:
obtain an indication of a blockage associated with a first transmit beam in the set of N best transmit beams; and
output, for transmission, a request-to-send (RTS) frame using a second transmit beam in the set of N best transmit beams, the RTS frame including an indication of the second transmit beam.

5. The apparatus of claim 4, wherein the processing system is further configured to cause the apparatus to:
obtain an indication of a removal of the blockage associated with the first transmit beam;
output, for transmission, a second RTS frame using the first transmit beam, the second RTS frame including an indication of the first transmit beam; and
obtain a clear-to-send (CTS) frame after the second RTS frame was output for transmission.

6. The apparatus of claim 5, wherein the processing system is further configured to cause the apparatus to:
communicate using the first transmit beam after obtaining the CTS frame.

7. The apparatus of claim 1, wherein the processing system is further configured to cause the apparatus to:
obtain data indicating a signal quality of the set of N best transmit beams; and
switch between transmit beams in the set of N best transmit beams based on at least one of the data or a configured switch time.

8. The apparatus of claim 7, wherein the configured switch time is associated with at least one of:
location of the apparatus;
a quality of service (QoS) requirement; or
telemetry data.

9. The apparatus of claim 1, wherein the processing system is further configured to cause the apparatus to:
obtain an indication of a blockage associated with at least one of a first transmit beam and a second transmit beam in the set of N best transmit beams; and
output, for transmission, a communication on a third best transmit beam from the set of N best transmit beams.

10. The apparatus of claim 4, wherein the processing system is further configured to cause the apparatus to:
obtain an indication of a blockage associated with the second transmit beam; and
output, for transmission, a second RTS frame using a third transmit beam in the set of N best transmit beams, the second RTS frame including an indication of the third transmit beam.

11. The apparatus of claim 10, wherein the processing system is further configured to cause the apparatus to:
obtain an indication of a removal of the blockage associated with at least one of the first transmit beam or the second transmit beam; and
output, for transmission, an RTS frame using the at least one of the first transmit beam or the second transmit beam for which the removal of the blockage was detected.

12. An apparatus device for wireless communication, comprising:
at least one memory comprising computer-executable instructions; and
a processing system that includes processor circuitry and memory circuitry that stores code, the processing system configured to cause the apparatus to:
operate in an omni receive mode during a sector level sweep (SLS), wherein the operation comprises sweeping through a plurality of transmit beams;
identify, based on the operation, a set of N best transmit beams, where N is an integer greater than one;
output, for transmission, an indication of the set of N best transmit beams.

13. The apparatus of claim 12, wherein the processing system is further configured to cause the apparatus to:
rank a set of best transmit-receive beam pairs, where the rank is based on the SLS and BRP.

14. The apparatus of claim 12, wherein the indication further includes at least one of:
a signal quality indicator for each of the N best transmit beams; or
a quantized difference in signal quality relative to a best transmit beam among the N best transmit beams.

15. The apparatus of claim 12, wherein the processing system is further configured to cause the apparatus to:
obtain a request-to-send (RTS) frame that includes an indication of a transmit beam; and
output, for transmission, a clear-to-send (CTS) frame using a receive beam corresponding to the transmit beam.

16. The apparatus of claim 12, wherein the processing system is further configured to cause the apparatus to:
obtain an indication of a blockage of at least one of a first transmit beam or a second transmit beam in the set of N best transmit beams; and
output, for transmission, a communication on a third best transmit beam from the set of N best transmit beams.

17. The apparatus of claim 15, wherein the processing system is further configured to cause the apparatus to:
obtain a second RTS frame that includes an indication of a second transmit beam, the second transmit beam being different from the transmit beam; and
output, for transmission, a second CTS frame using a receive beam corresponding to the second transmit beam.

18. The apparatus of claim 15, wherein the processing system is further configured to cause the apparatus to:
obtain an indication of a removal of the blockage; and
output, for transmission, a third CTS frame using a receive beam corresponding to either the first or second transmit beam for which the removal of the blockage is associated with.

19. An apparatus for wireless communication, comprising:
at least one memory comprising computer-executable instructions; and
a processing system that includes processor circuitry and memory circuitry that stores code, the processing system configured to cause the apparatus to:
obtain, based on a sector level sweep (SLS) of a plurality of transmit beams, an indication of a set of N best transmit beams in the plurality of transmit beams, where N is an integer greater than one;
perform a beam refinement phase (BRP) for each of the N best transmit beams;
obtain an indication of a blockage associated with a first transmit beam in the set of N best transmit beams; and
output, for transmission, a request-to-send (RTS) frame via a second transmit beam in the set of N best transmit beams, the RTS frame including an indication of the second transmit beam.

20. The apparatus of claim 19, wherein the processing system is further configured to cause the apparatus to:
detect a removal of the blockage associated with the first transmit beam;
output, for transmission, an RTS frame using the first transmit beam; and
obtain a clear-to-send (CTS) frame after outputting the RTS frame.
